(19) United States
(12) Patent Application Publication
(10) Pub. No.: US 2010/0006605 A1
(43) Pub. Date: Jan. 14, 2010

(54) Electric caulking gun

(75) Inventors: Chia Hsien Sung, Taichung City (TW); Jui-Lung Chien, Taichung City (TW)

Correspondence Address: CHARLES E. BAXLEY, ESQUIRE, 90 JOHN STREET, SUITE 309, NEW YORK, NY, 10038, US

(73) Assignee: Kent Bridge Enterprise Co., Ltd.

(21) Appl. No.: 12/217,882

(22) Filed: Jul. 9, 2008

(51) Int. Cl. G01F 11/00

(52) U.S. Cl. 222/327

(57) ABSTRACT

An electric caulking gun is provided with a clutch. The clutch is connected to a button of the electric caulking gun. When the button is free, the clutch is idle so that power cannot be transmitted from a motor to a pusher. Therefore, the pusher is idle, i.e., it cannot extrude water proofing material from a package. When the button is pressed, the clutch is active so that power can be transmitted from the motor to the pusher. Therefore, the pusher is active, i.e., it extrudes the water proofing material from the package.

### FIELD OF INVENTION

The present invention relates to an electric caulking gun and, more particularly, to a clutch for use in an electric caulking gun.

### BACKGROUND OF INVENTION

Caulking guns are used to fill waterproofing material in seams. There are manual caulking guns and electric caulking guns. An example of manual caulking guns is found in U.S. Pat. No. 1,986,166.

Electric caulking guns are found in U.S. Pat. Nos. 5,775,539, 5,909,830 and 6,123,235 for example. Such an electric caulking gun includes an epicyclic gear system. The epicyclic gear system includes a ring gear, planet gears engaged with the ring gear, a first axle connected to a motor, a sun gear attached to the first axle and engaged with the planet gears, a disc for supporting the planet gears, a second axle extended from the disc, and a ring gear-engaging projection. In a position, the ring gear-engaging projection is disengaged from the ring gear to allow the rotation of the ring gear but prevent the rotation of the second axle. Hence, the waterproofing material is not provided. In another position, the ring gear-engaging projection is engaged with the ring gear to prevent the rotation of the ring gear but allow the rotation of the second axle. Hence, the waterproofing material is provided.

Referring to FIG. 1, a conventional electric caulking gun 10 includes a button 11, a battery 12 connected to the button 12, a motor 13 energized with the battery 12, a transmission 14 connected to the motor 13, a first gear 15 connected to the transmission 14, a second gear 16 including an external side engaged with the first gear 15 and an internal side engaged with a screw 17, a disc 19 attached to the screw 17, and a trough 18. The waterproofing material is stored in a package 20. The package 20 includes a nozzle 21 at an end. The package 20 is supported on the trough 18 so that the nozzle 21 is extended beyond the trough 18 and another end of the package 20 is pushed with the disc 19. Thus, the waterproofing material can be extruded from the package 20.

The present invention is therefore intended to obviate or at least alleviate the problems encountered in prior art.

### SUMMARY OF INVENTION

It is the primary objective of the present invention to provide an electric caulking gun equipped with a clutch.

According to the present invention, the clutch includes a frame, a rotational element, an epicyclic gear system, a lever and rollers. The frame includes a circular chamber, a polygonal chamber with a polygonal wall, an aperture for communicating the circular chamber with the polygonal chamber, a cavity in communication with the polygonal chamber, and a cutout in a periphery thereof and in communication with the cavity. The rotational element includes a drum and a ring extended from the drum. The drum is disposed in the circular chamber. The ring is inserted in the polygonal chamber through the aperture. The epicyclic gear system includes an axle inserted through the ring and a ring gear fit in the drum. The lever includes an end formed with a ring disposed in the cavity, another end connected to a button from the cavity through the cutout, and tabs formed on a side of the ring and separated from each other by gaps. The rollers are formed with a diameter larger than the shortest distance between the polygonal wall and an external side of the ring. The rollers are disposed in the gaps while the tabs can drive the rollers between a first position for allowing the rotation of the rotational element in the frame and a second position for preventing the rotation of the rotational element in the frame.

Other objectives, advantages and features of the present invention will become apparent from the following description referring to the attached drawings.

### BRIEF DESCRIPTION OF DRAWINGS

The present invention will be described via the detailed illustration of the preferred embodiment versus a conventional electric caulking gun referring to the drawings.

FIG. 1 is a cross-sectional view of a conventional electric caulking gun.

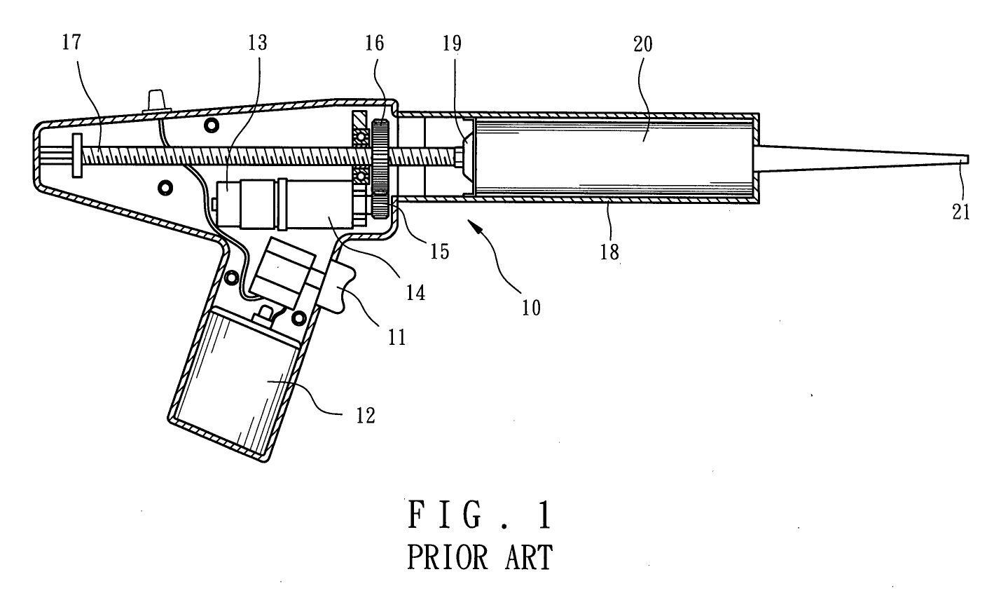

FIG. 2 is a perspective view of an electric caulking gun according to the preferred embodiment of the present invention.

FIG. 3 is an exploded view of the electric caulking gun of FIG. 2.

FIG. 4 is a cross-sectional view of the electric caulking gun shown in FIG. 2.

FIG. 5 is a perspective view of a mechanism for extruding waterproofing material.

FIG. 6 is an exploded view of the mechanism shown in FIG. 5.

FIG. 7 is a cross-sectional view of a clutch shown in FIG. 6.

FIG. 8 is another cross-sectional view of the clutch shown in FIG. 7.

FIG. 9 is another cross-sectional view of the clutch shown in FIG. 8.

FIG. 10 is a cross-sectional view of the clutch in another position than shown in FIG. 9.

### DETAILED DESCRIPTION OF PREFERRED EMBODIMENT

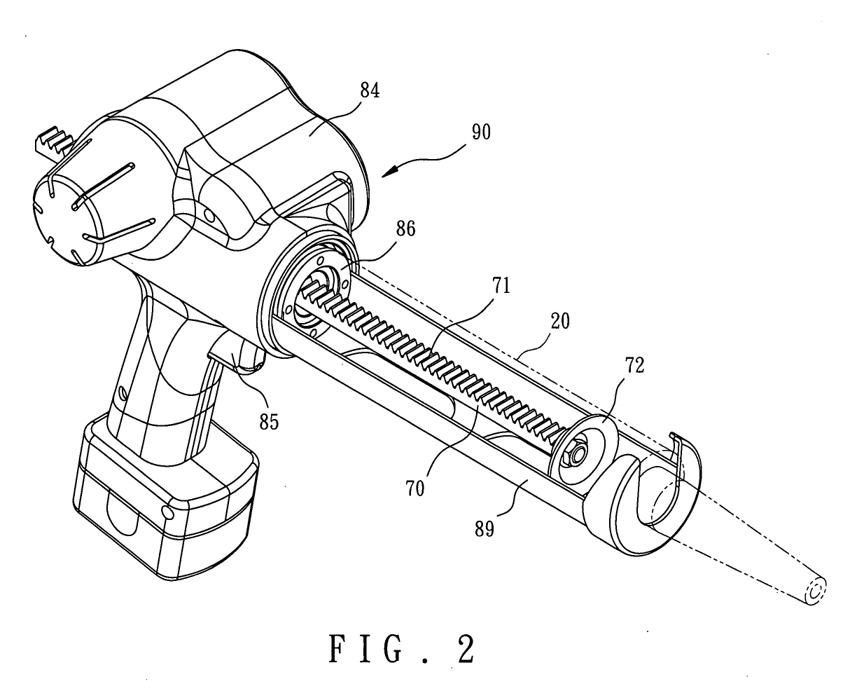

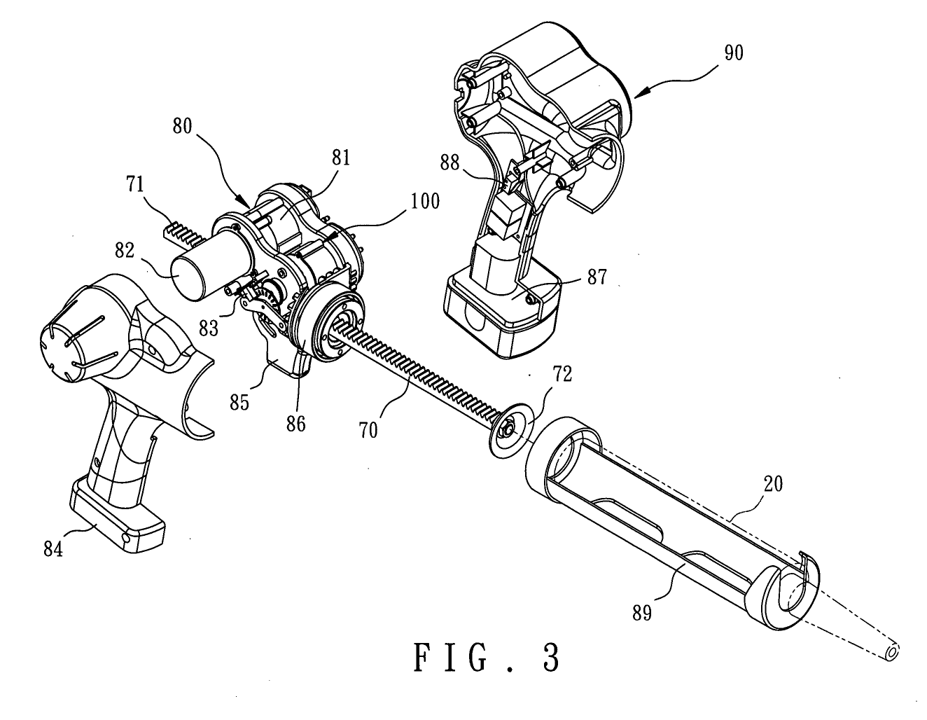

Referring to FIGS. 2 and 3, according to the preferred embodiment of the present invention, an electric caulking gun 90 includes a shell 84, a trough 89, a joint 86, a pusher 70, a core 80, and a clutch 100. The shell 84 consists of two parts. The trough 89 is connected to the shell 84 with the joint 86. The trough 89 is used to support a package 20. The package 20 contains waterproofing material. The package 20 includes a closed end and an open end in the form of a nozzle.

The pusher 70 is used to push the package 20 by the closed end to dispense the waterproofing material from the package 20 through the open end. The pusher 70 includes a rack 71 and a disc 72 attached to an end of the rack 71.

The core 80 is used to drive the pusher 70. The core 80 includes a motor 82, a transmission 81, a sensor 83, a button 85, a micro switch 88, and a battery 87. The motor 82 is energized with the battery 87. The transmission 81 is connected to the motor 82. The button 85 is movably connected to the shell 84. The micro switch 88 is provided between the motor 82 and the battery 87. The micro switch 88 is in contact with the button 85. By pushing the button 85, the micro switch 88 is operated to turn on and off the motor 82.

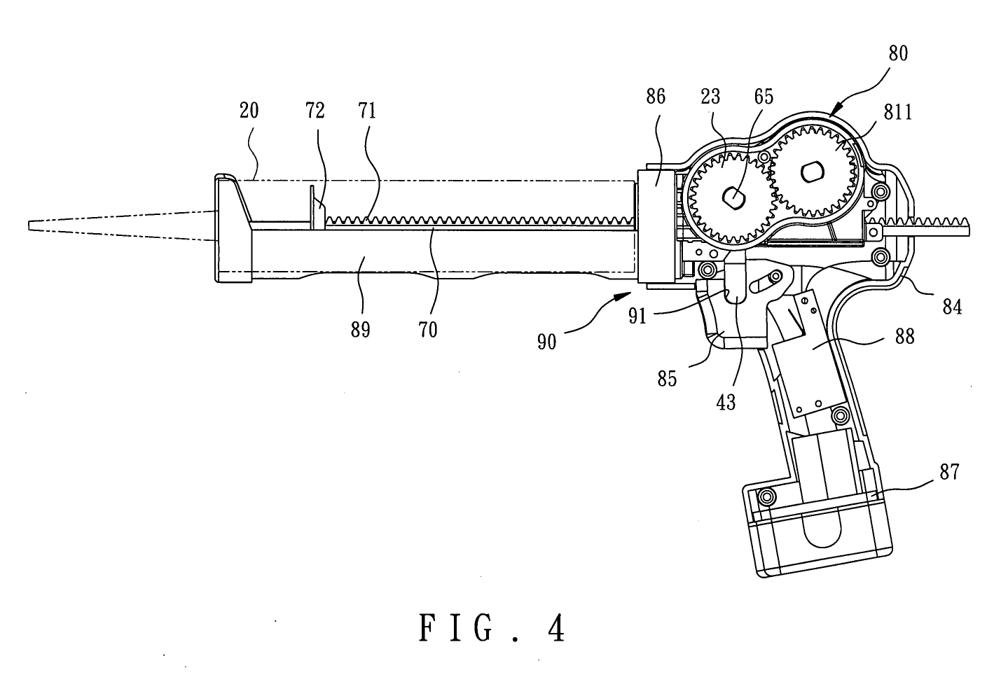

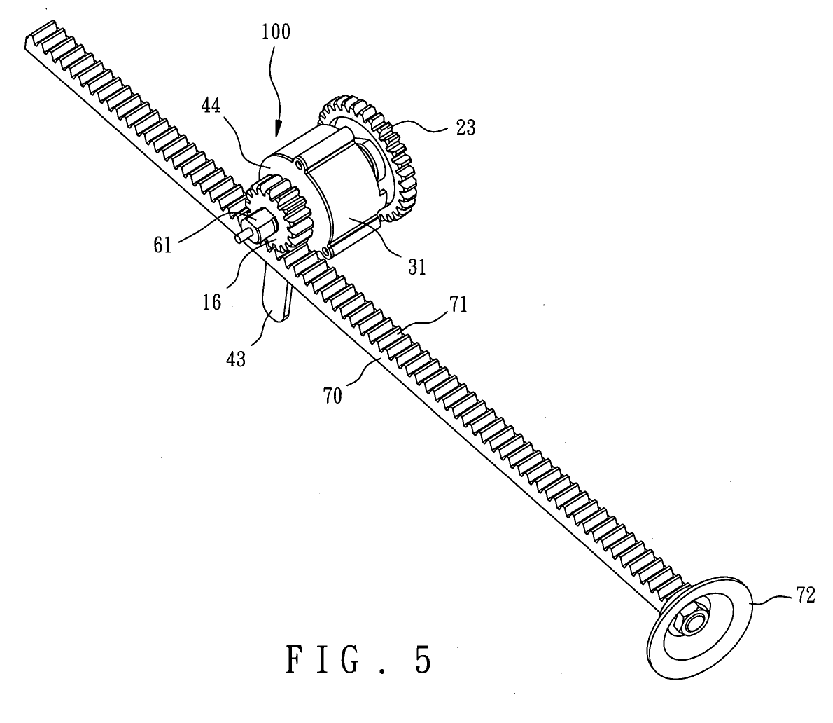

Referring to FIGS. 4 and 5, the transmission 81 includes a gear 811 engaged with a gear 23.

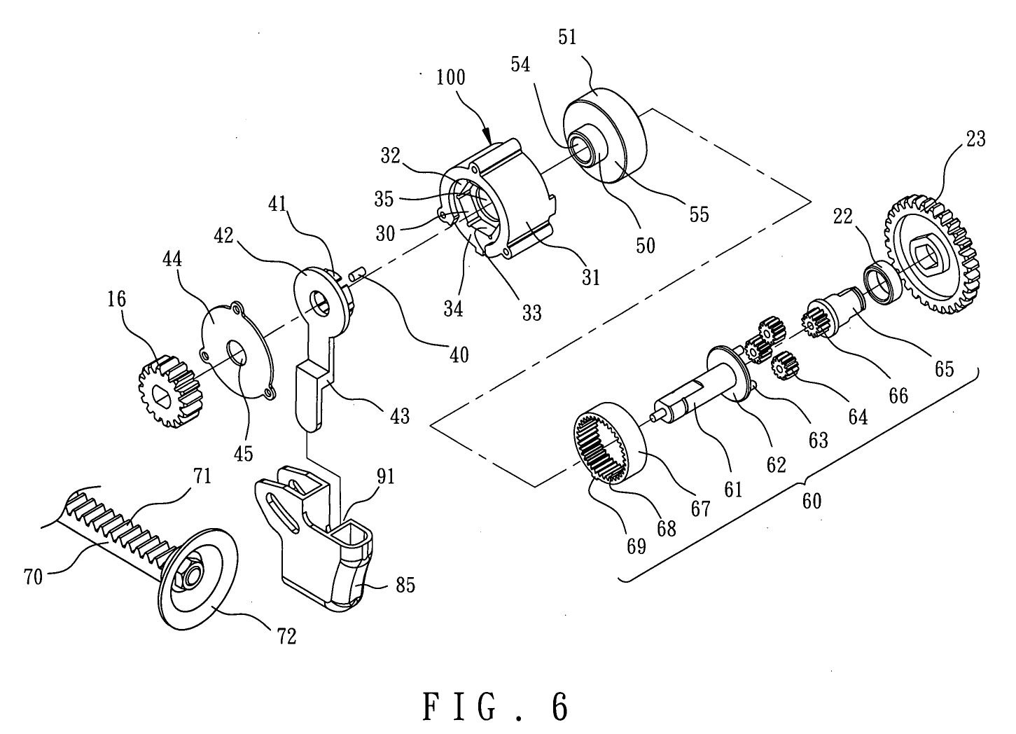

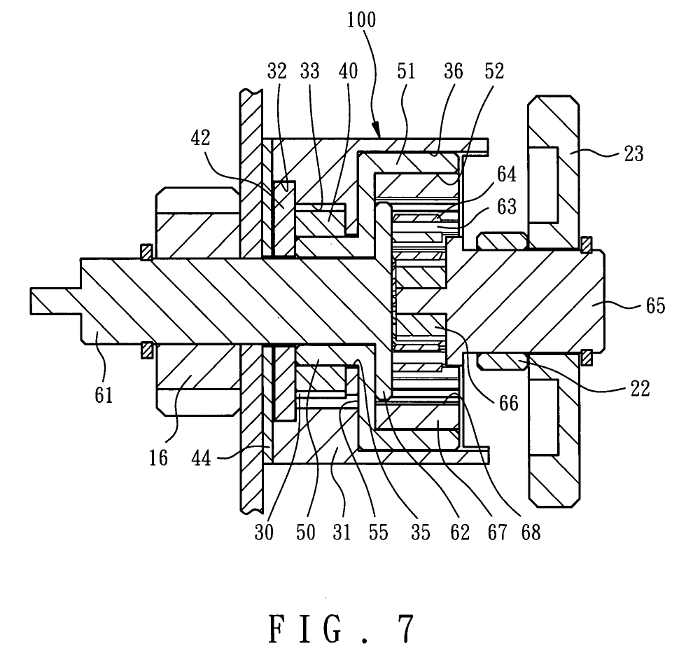

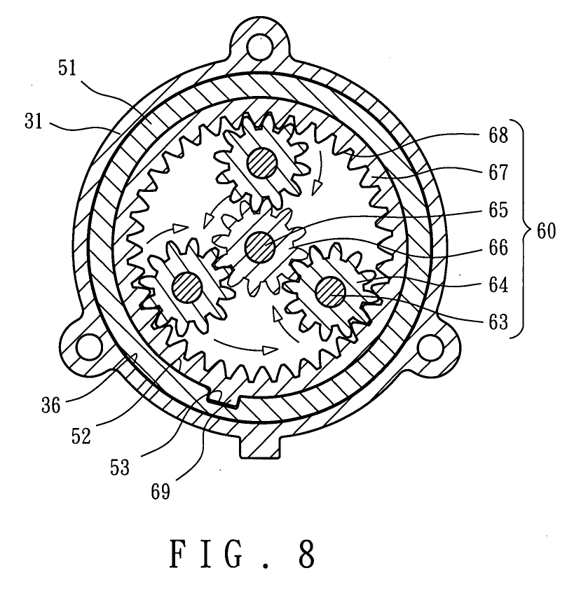

Referring to FIGS. 6 through 8, the clutch 100 includes a rotational unit disposed in a frame 31 and an epicyclic gear system 60 disposed in the rotational unit. The frame 31 includes a cavity 30 defined therein, a chamber 32 in communication with the cavity 30, and a chamber 36 in communication with the chamber 32 via an aperture 35. A cutout 34 is defined in the periphery of the frame 31 so that the cutout 34 is in communication with the cavity 30. The chamber 32 includes a polygonal wall 33. The chamber 36 is circular.

The rotational unit is formed with a ring 50 and a drum 51. The diameter of the ring 50 is smaller than that of the drum 51 so that a shoulder 55 is formed between them. An aperture 54 is defined in the ring 50. A recess 53 is defined in an internal side of the drum 51. The ring 50 is inserted in the chamber 32 via the chamber 35 while the drum 51 is disposed in the chamber 36.

The epicyclic gear system 60 includes a ring gear 67, a disc 62, three planet gears 64, a sun gear 66, an axle 65, and a ring gear 67. The axle 65 is connected to the gear 23. A ring 22 and a clip are mounted on the axle 65 to position the gear 23. The sun gear 66 is formed together with the axle 65. The planet gears 63 are engaged with the sun gear 66. Three axles 63 are formed on a side of the disc 62 while the axle 61 is formed on an opposite side of the disc 62. Each of the axles 63 is used to support a related one of the planet gears 64. The ring gear 67 is formed with teeth 68 on an internal side thereof and a key 69 on an external side thereof. The annular ring 67 is disposed in the rotational unit. The key 69 is fit in the recess 53 to prevent the rotation of the annular ring 67 within the rotational unit. The axle 61 is inserted through the ring 50 of the rotational unit.

The lever 43 includes an end formed with a ring 42 disposed in the cavity 30 and another end inserted in a recess 91 defined in the button 85 through the cutout 34. Tabs 41 are formed on a side of the ring 42. Each of the tabs 41 is separated from a next one of the tabs 41 by a gap. A roller 40 is disposed in each of the gaps between the tabs 41. The diameter of the rollers 40 is larger than the shortest distance between the polygonal wall 33 and an external side of the ring 50. The rollers 40 are used for contact with the polygonal wall 33 of the chamber 32 of the frame 31.

A cover 44 is attached to the frame 31 to keep the ring 42 within the cavity 30. The cover 44 includes an aperture 45 through which the axle 61 is inserted.

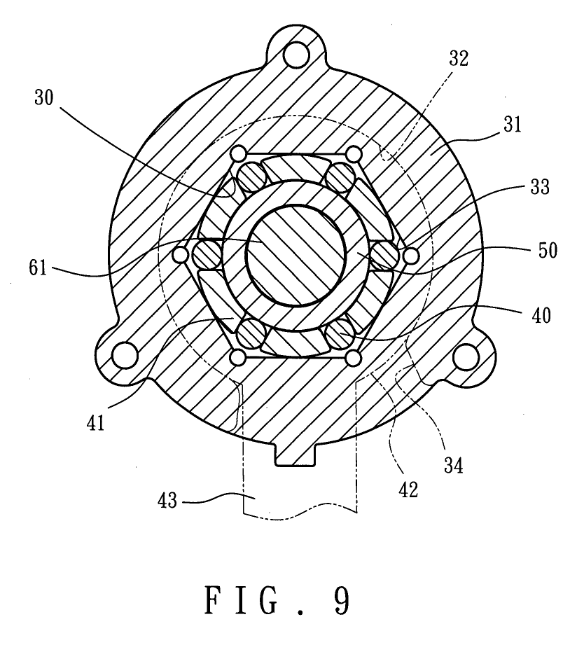

Referring to FIG. 9, the button 85 is in an idle position normally so that the lever 43 is in an idle position as well. The rollers 40 are disposed in corners of the chamber 32 of the frame 31. The rotation of the ring 50 of the rotational unit within the frame 31 is allowed, and so is the rotation of the ring gear 67. Therefore, the rotation of the axle 61 is prevented. The rotation of the gear 16 is also prevented so that the movement of the rack 71 is prevented. Hence, the pressing on the package 20 is prevented so that the waterproofing material is retained in the package 20.

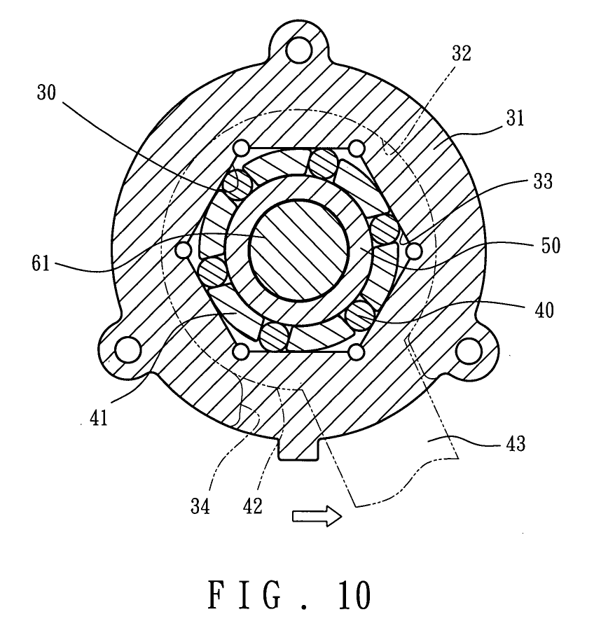

Referring to FIG. 10, when the button 85 is in an active position, the lever 43 is in an active position as well. The rollers 40 are pressed between the polygonal wall 33 of the chamber 32 of the frame 31 and an external side of the ring 50 of the rotational unit. The rotation of the ring 50 of the rotational unit within the frame 31 is prevented, and so is the rotation of the ring gear 67. Hence, the rotation of the axle 61 is allowed. The rotation of the gear 16 is also allowed so that the movement of the rack 71 is allowed. Hence, the pressing on the package 20 is allowed so that the waterproofing material is extruded from the package 20.

The present invention has been described via the detailed illustration of the preferred embodiment. Those skilled in the art can derive variations from the preferred embodiment without departing from the scope of the present invention. Therefore, the preferred embodiment shall not limit the scope of the present invention defined in the claims.

1. A clutch for use in an electric caulking gun, the clutch comprising:
a frame (31) comprising a circular chamber (36), a polygonal chamber (32) with a polygonal wall (33), an aperture (35) for communicating the circular chamber (36) with the polygonal chamber (33), a cavity (30) in communication with the polygonal chamber (32), and a cutout (34) in a periphery thereof and in communication with the cavity (30);
a rotational unit comprising a drum (51) disposed in the circular chamber (36) and a ring (50) extended from the drum (51) into the polygonal chamber (32) through the aperture (35);
an epicyclic gear system (60) comprising an axle (61) inserted through the ring (50) and a ring gear (67) fit in the drum (51);
a lever (43) comprising an end formed with a ring (42) disposed in the cavity (30), another end connected to a button (85) from the cavity (30) through the cutout (34), and tabs (41) formed on a side of the ring (42) and separated from each other by gaps; and
rollers (40) formed with a diameter larger than the shortest distance between the polygonal wall (33) and an external side of the ring (50), wherein the rollers (40) are disposed in the gaps while the tabs (41) can drive the rollers (40) between a first position for allowing the rotation of the rotational unit in the frame (31) and a second position for preventing the rotation of the rotational unit in the frame (31).

2. The clutch according to claim 1, wherein the drum (51) comprises a recess (53) defined in an internal side, and the ring gear (67) comprises a key (69) fit in the recess (53).

3. A clutch for use in an electric caulking gun, the clutch comprising:
a frame (31) comprising a circular chamber (36), a polygonal chamber (32) with a polygonal wall (33), an aperture (35) for communicating the circular chamber (36) with the polygonal chamber (33), a cavity (30) in communication with the polygonal chamber (32), and a cutout (34) in a periphery thereof and in communication with the cavity (30);
a rotational unit comprising a drum (51) disposed in the circular chamber (36) and a ring (50) extended from the drum (51) into the polygonal chamber (32) through the aperture (35);
an epicyclic gear system (60) comprising:
an input axle (65);
a sun gear (66) attached to the input axle (65);
at least one planet gear (64) engaged with the sun gear (66);
a disc (62) for supporting the planet gear (64);
an output axle (61) connected to the disc (62) and inserted through the ring (50); and
a ring gear (67) fit in the drum (51) and engaged with the planet gear (64);
a lever (43) comprising an end formed with a ring (42) disposed in the cavity (30), another end connected to a button (85) from the cavity (30) through the cutout (34), and tabs (41) formed on a side of the ring (42) and separated from each other by gaps; and
rollers (40) formed with a diameter larger than the shortest distance between the polygonal wall (33) and an external side of the ring (50), wherein the rollers (40) are disposed in the gaps while the tabs (41) can drive the rollers (40) between a first position for allowing the rotation of the rotational unit in the frame (31) and a second position for preventing the rotation of the rotational unit in the frame (31).
